(19) United States
(12) Patent Application Publication
(10) Pub. No.: US 2011/0174163 A1
(43) Pub. Date: Jul. 21, 2011

(54) Kettle corn kettle, lid, and utensils

(76) Inventor: Renee Jenniges, New London, MN (US)

(21) Appl. No.: 12/691,677

(22) Filed: Jan. 21, 2010

(51) Int. Cl. A23L 1/18

(52) U.S. Cl. 99/323.5

(57) ABSTRACT

A kettle, lid, and utensils for cooking kettle corn comprising, a kettle body, lid, utensil, and splatter guard. The kettle body contains curved annular side walls, bottom, and open top. The lid contains a central aperture and radial knob. The utensil contains a handle end, working end, and shaft connecting the handle end and working end. The splatter guard contains a central aperture and radial cut. The combination of these elements allows an individual to easily cook kettle corn on their home stove.

### BACKGROUND OF THE INVENTION

1. Field of the Invention

The present invention relates to kitchen utensils and more specifically to a kettle, lid, and utensil to make kettle corn at home on a stove top.

2. Description of the Prior Art

Popcorn has been a snack loved by many for hundreds of years. As popcorn's popularity has increased, individuals are developing new and unique flavors and recipe's to heighten this enjoyment in popcorn. Recently, kettle corn, a sugary and salty mix, created using high heat and the addition of caramelized sugar and salt has become popular. Typically, kettle corn is produced outdoors at fairs and festivals in large batches using a kettle made out of steel or copper. The mix of popping corn and sugar is popped at an intense heat with continual stirring, usually by using a large wooden paddle. Due to kettle corn's popularity and desirable flavor, people are looking for ways to make and enjoy this delicious snack at home.

Conventional popcorn cookers designed for use on a stove consist of a pot, lid, and stirring mechanism attached to the lid, typically this stirring mechanism is turned by a crank and gear assembly. Oil and popping corn are added to the pot and stirred with the stirring mechanism while being heated. This stirring mechanism allows for even heating of the corn and attempts to keep the corn from burning. The pot used in these devices is straight walled and in the form of a typical pot for heating on the stove. The stirring mechanism typically consists of a straight metal rod that turns around the bottom of the pot as the crank is turned. Other stirrer's, as in Brooks U.S. Pat. No. 4,202,256, have been disclosed that attach to a conventional pot lid, wherein the turning of the lid moves the stirrer.

Although these traditional pot and stirring mechanism's work for traditional popcorn, the making of kettle corn is difficult with these devices due to the addition of sugar and the requirement for a higher amount of heat. Therefore, a need for other alternatives, preferably ones that withstand the added heat, allow for stirring in both a horizontal and vertical stirring direction, and are robust enough to adequately mix the popped corn and sugar together are needed.

### SUMMARY OF THE INVENTION

The present invention provides an apparatus for cooking kettle corn comprising a kettle body, a lid, and a utensil. The kettle body is adapted to be placed onto a stove and has an open top, a bottom designed to retain and conduct an even amount of heat, and curved annular side walls in communication with the bottom and open top. The annular side walls are curved to allow the popped corn to move outward and upward from the bottom of the kettle body to prevent burning and charring of popped corn.

The lid is adapted to fit on the open top of the kettle body and contains a central aperture and a radial knob. A utensil is adapted to fit through the central aperture and contains a handle end, a working end, a shaft connecting the hand end and working end, and a splatter guard connected to the shaft. The handle end allows the user to comfortably grasp and manipulate the utensil. The working end can contain a multitude of configurations to aide in the stirring and mixing of popped and unpopped corn with the sugary mixture that gives kettle corn its unique flavor. Anticipated configurations are a spatula like end, a horizontal mixing blade, a whisk type mixing element, a spoon, a slotted spoon, pasta spoon or spaghetti fork, a ladle, and other similar utensil ends. The shaft is stepped wherein the upper portion near the handle end has a diameter greater than the diameter of the lower portion near the working end. Ideally this step occurs approximately 3 inches below the handle end. This step prevents the utensil from being placed too far into the kettle. The splatter guard contains a central aperture and radial cut to allow it to be placed around the shaft. This fit must be tight enough to allow the utensil to be suspended from the splatter guard when the utensil is pulled up and away from the bottom of the kettle. The diameter of the splatter guard must be the same or greater than the central aperture of the lid to protect the user from splatter while using the utensil. This splatter guard should be flexible and have the ability to flex around the shaft allowing a tight fit. Ideally, the splatter guard is constructed out of a rubber or silicone based material due to its excellent resiliency and heat absorption properties.

In other embodiments of the invention, the splatter guard and central aperture of the lid may be designed such that the splatter guard may communicate with the central aperture and be securely locked into the central aperture by turning or forcibly pushing the guard into the central aperture. In this embodiment the splatter guard would be secured to the central aperture of the lid and the user would be able to move the utensil vertically and rotationally. Another possible way of securing the splatter guard to the lid is through magnetic forces. The splatter guard and the central aperture would communicate through magnetic attraction where the splatter guard would magnetically attach to the area around the central aperture when in close proximity. In this configuration the splatter guard would be composed of a resilient magnetic material or have a magnetic strip of material secured to its underside.

In one preferred embodiment of the present invention, the lid is transparent and constructed out of glass or a high density shatter resistant plastic to allow the user to watch the popcorn while popping and stirring to ensure the mixture of kettle corn sugar and popcorn is adequately mixed.

In another preferred embodiment of the present invention, the working end contains a horizontal stirring rod attached at the stirring rod center perpendicular to the shaft and having a length corresponding to the diameter of the pot bottom. It is import that the length of the rod corresponds to the pot bottom to ensure that the manipulation of the utensil will reach all of the sides of the kettle to allow for adequate mixing and ensure even heating of the unpopped corn.

Preferably the kettle is constructed out of stainless steel due to its ability to evenly conduct heat, be cleaned and sterilized easily, and be stamped for mass production. Further, preferably the kettle bottom is constructed to be thicker than the annular walls to allow for even heating of the bottom of the kettle to prevent uneven heating of the unpopped corn.

### BRIEF DESCRIPTION OF THE SEVERAL VIEWS OF THE DRAWING(S)

The accompanying drawings are included to provide a further understanding of the present invention and are incorporated in and constitute a part of this specification. The drawings illustrate exemplary embodiments of the present invention and together with the description serve to further explain the principles of the invention. Other aspects of the invention and the advantages of the invention will be better appreciated as they become better understood by reference to the Detailed Description when considered in conjunction with accompanying drawings, and wherein:

FIG. 1 is an exploded perspective view of the kettle corn kettle, lid, and utensil according to the present invention;

FIG. 2 is a top view of the lid of the device according to the present invention;

FIG. 3 is a side view of the utensil of the device according to the present invention.

FIG. 4 is a top view of the splatter guard according to the present invention.

### DETAILED DESCRIPTION OF THE INVENTION

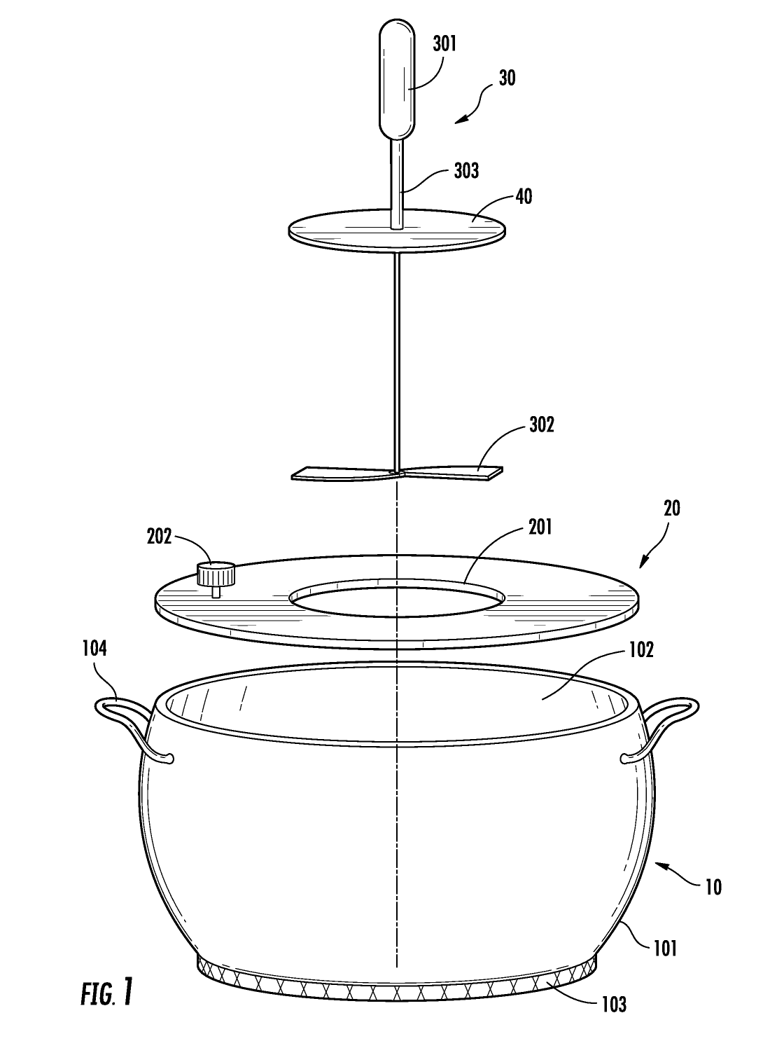

Referring now to FIG. 1, kettle corn kettle, lid, and utensil according to the present invention, there is shown a kettle 10. This kettle is designed to fit onto a stove burner and for the cooking of popcorn. Kettle 10 has an annular side wall 101 an opening 102, bottom 103, and handles 104. Side wall 101 is curved wherein the diameter of the opening 102 is larger than the diameter of the bottom 103. This curve is necessary to prevent the burring of popped corn. It creates a space for the expansion of the corn and moves the popped corn out and away from the hottest portion of the kettle the bottom 103. Bottom 103 must adequately transfer heat from the stove burner to the contents of kettle, therefore it must be constructed of a metal that is a good conductor of heat.

A lid 20 is adapted to fit the opening 102 and contains a central aperture 201 and a radial knob 202. Because of the central aperture 201, the traditional position of a knob at the center of a pot lid must be moved to a location away from the center. Ideally, this lid is constructed out of a material that is transparent, preferably glass or a high density shatter resistant plastic. A transparent lid allows the user to see the corn pop and to see the progress of mixing the sugar with the popped corn.

A utensil 30 contains a handle end 301, a working end 302, a splatter guard 40, and a shaft 303. The shaft 303 connects the handle end 301 and working end 302. The splatter guard 40 is attached to the shaft and has a diameter equal to or greater than the diameter of the central aperture 201. The handle end 301 can be designed in several configurations to allow comfortable grip of the utensil and allow the user to easily manipulate the utensil. The materials used to create this handle end may be wood, plastic, metal, rubber, silicone or any combination of these. Ideally, this handle end 301 is enlarged from the shaft so it easily fits into the hand of the user.

The working end 302 can be composed of several configurations that allow the user to adequately stir unpopped corn and popped corn with the kettle corn sugar. Recommended configurations would be a long horizontal shaft, a spatula like end, or a wire whisk type end. This utensil 30 is then placed through the central aperture of the lid 201 where the user manipulates the utensil in both a horizontal and vertical direction to adequately stir the mix of sugar and popped corn together. If the working end of the utensil 302 is too large to fit through this central aperture 201, the lid can be placed over the handle end 301.

Referring now to FIG. 2, the top view of the lid according to the present invention, there is shown the lid 20 adapted to fit the opening 102, the central aperture 201, radial knob 202, and top 203. Ideally, top 203 is transparent to allow the user to see the mixture and gauge the cooking process.

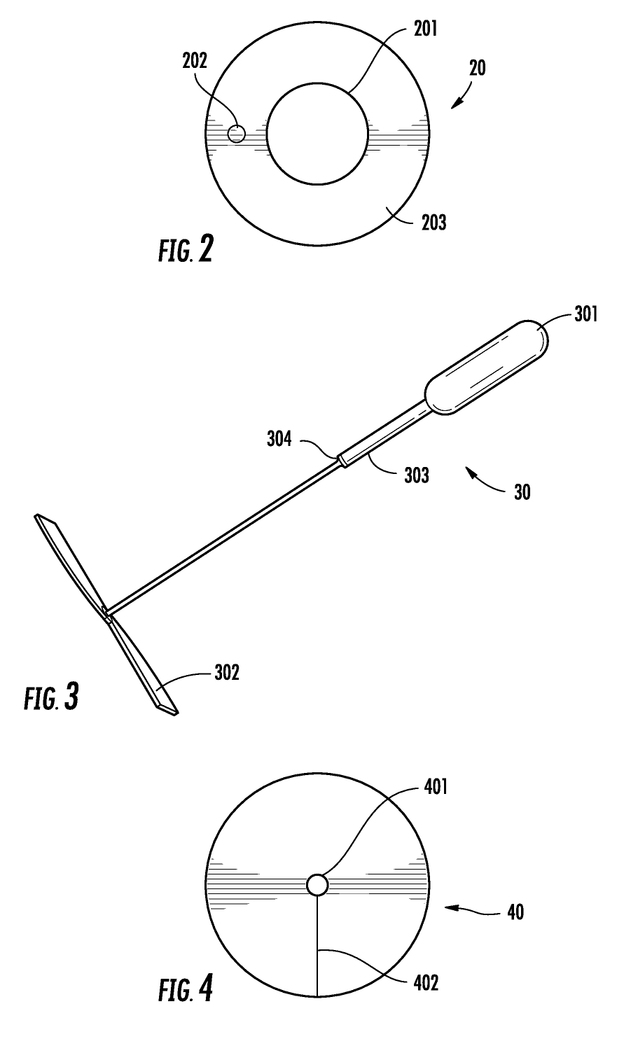

Referring now to FIG. 3, the side view of the utensil according to the present invention, there is shown the utensil 30 containing the handle end 301, the working end 302, the shaft 303, and notch 304. The handle end 301 is designed to comfortably fit into the hand of the user to allow for easy manipulation of the utensil throughout the cooking process. The working end 302 is shown with a horizontal stirrer attached at its center perpendicular to the shaft 303. Preferably this stirrer is the same length as the diameter of the kettle bottom to ensure adequate mixing of ingredients. The notch 304 is designed to allow the splatter guard 40 to fit tightly around the shaft and to prevent the splatter guard 40 from moving up during manipulation of the utensil 30.

Referring now to FIG. 4, the top view of the splatter guard 40 according to the present invention, there is seen the central aperture 401 and radial cut 402. The central aperture 401 is designed to tightly fit around the shaft and therefore its diameter should be equal to the diameter of the shaft. The notch 304, as seen in FIG. 3, is larger than the central aperture 401, and helps to keep the splatter guard 40 in place. The radial cut 402, is a complete perforation of the splatter guard 40 in a radial direction from the central aperture 401 to the outer edge of the splatter guard 40. This radial cut 402, allows the splatter guard 40, to be easily placed onto the shaft. Ideally the splatter guard 40 is composed of a resilient material, such as silicone or rubber, to ensure a tight fit around the shaft and to allow for it to flex and bend upon insertion into the notch 304. Further, it is necessary that the diameter of the splatter guard 40 be equal or greater than the diameter of the central aperture 201 of the lid 20. This will prevent splatter of oil and popcorn, during the cooking process.

What is claimed is:

1. An apparatus for cooking kettle flavored popping corn comprising:
a kettle body adapted to placed onto a stove and the kettle body having
an open top,
a bottom,
an outwardly curved annular side wall in communication with the bottom and open top;
a lid adapted to fit the open top and the lid having
a central aperture, and
a radial knob;
a utensil adapted fit through the central aperture and the utensil having
a handle end,
a working end,
a shaft attached to the handle end and working end; and
a splatter guard with a diameter equal to the diameter of the central aperture connected to the utensil, wherein the splatter guard prevents the contents of the kettle from leaving through the central aperture.

2. The apparatus of claim 1, wherein the utensil contains a notch to secure the splatter guard.

3. The apparatus of claim 1, wherein the utensil working end consists of a horizontal blade attached perpendicular to the shaft.

4. The apparatus of claim 1, wherein the utensil working end consists of flat blade.

5. The apparatus of claim 1, wherein the utensil working end consists of a multiple wires configured like a whisk.

6. The apparatus of claim 1, wherein the utensil working end consists of spoon.

7. The apparatus of claim 1, wherein the utensil working end consists of a slotted spoon.

8. The apparatus of claim 1, wherein the utensil working end consists of a ladle.

9. The apparatus of claim 1, wherein the utensil working end consists of a pasta spoon.

10. The apparatus of claim 1, wherein the kettle is stainless steel.

11. The apparatus of claim 1, wherein the diameter of the splatter guard is greater than the diameter of the central aperture.

12. The apparatus of claim 1, wherein the splatter guard and lid central aperture connect magnetically.

13. The apparatus of claim 1, wherein the splatter guard and lid central aperture lock together.
